(19) United States
(12) Patent Application Publication
(10) Pub. No.: US 2022/0121650 A1
(43) Pub. Date: Apr. 21, 2022

(54) METHOD AND SYSTEM FOR MANAGING STATES FOR A BLOCKCHAIN INCLUDING A STATE DATABASE OF TREE STRUCTURE

(71) Applicant: COMMON COMPUTER INC., Seoul (KR)

(72) Inventors: Minhyun KIM, Seoul (KR); Dongil SEO, Seoul (KR); Seonghwa YUN, Seongnam-si (KR); Youngseo YOO, Seoul (KR); Minsu LEE, Seoul (KR); Sanghee CHOI, Seongnam-si (KR)

(21) Appl. No.: 17/505,691

(22) Filed: Oct. 20, 2021

(30) Foreign Application Priority Data
Oct. 20, 2020 (KR) 10-2020-0136084

(51) Int. Cl. G06F 16/23; G06F 16/22

(52) U.S. Cl. CPC G06F 16/2379; G06F 16/2246

(57) ABSTRACT

A method for managing states for a blockchain including a state database of a tree structure is provided, which includes: receiving a first transaction including a first state path and a first value from a client; generating a first set of state nodes for generating a state database of a current block, based on one or more state nodes included in a state database of a previous block existing on the first state path; setting a state of a specific state node of the generated first set of state nodes of the state database of the current block by using the first value; retrieving a first set of sibling state nodes for the one or more state nodes included in the state database of the previous block existing on the first state path; and associating the retrieved first set of sibling state nodes with the first set of state nodes of the state database of the current block.

### CROSS-REFERENCE TO RELATED APPLICATION

This application claims priority under 35 U.S.C § 119 to Korean Patent Application No. 10-2020-0136084 filed in the Korean Intellectual Property Office on Oct. 20, 2020, the entire contents of which are hereby incorporated by reference.

### TECHNICAL FIELD

The present disclosure relates to a method and a system for managing states for a blockchain, which are capable of state version management and state proof in a blockchain including a state database of a tree structure.

### BACKGROUND

A block used in a general blockchain includes a block header and a block body. Here, a version, a block hash, a nonce, and the like included in the block header, and transaction information, and the like included in the block body may be linked in a form of a linked list to form one chain.

In addition, when transaction information included in each of the blocks including the block header and the block body is applied to a state database, data duplication occurs between state databases belonging to each block. In other words, when a new transaction occurs on the blockchain network, not only the information changed or updated due to the transaction, but also the previous information is stored in the state database. Accordingly, there is a problem in that the waste of computing resources due to the duplication of state data is aggravated.

Meanwhile, various consensus protocols are being used for validation and consensus on transaction information stored in the blockchain. For example, when using a permission-based consensus protocol such as Streamlet, a blockchain may include a plurality of unfinalized chains or forks at a specific point in time. Each fork and each block within the fork has an intermediate state different from each other, which can be modified by different transactions. Theoretically, a block may be attached to any of the unfinalized blocks, and blockchain state nodes must validate the transaction included in the block by executing the corresponding transaction against a snapshot of the database state that reflects the chain to which the new block is attached.

### SUMMARY

In order to solve the problems described above, the present disclosure provides a method, a computer program stored in a recording medium, and an apparatus (system) for managing states for a blockchain including a state database of a tree structure that forms a result of transaction information included in a block in the tree structure.

The present disclosure may be implemented in a variety of ways, including a method, a device (system) or a computer program stored in a readable storage medium.

According to an embodiment, a method for managing states for a blockchain including a state database of a tree structure is provided, which may be performed by at least one processor and include receiving a first transaction including a first state path and a first value from a client, generating a first set of state nodes for generating a current block, based on one or more state nodes included in a state database of a previous block existing on the first path, setting a state of a specific state node of the generated first set of state nodes of the current block by using the first value, retrieving a first set of sibling state nodes for the one or more state nodes included in the state database of the previous block existing on the first state path, and associating the retrieved first set of sibling state nodes with the first set of state nodes of the current block.

According to an embodiment, associating the retrieved first set of sibling state nodes with the first set of state nodes of the state database of the current block may include storing a version of the current block in the retrieved first set of sibling state nodes.

According to an embodiment, the method may further include receiving a second transaction including a second state path and a second value from the client, generating a second set of state nodes for generating the state database of the current block, based on one or more state nodes included in a state database of a previous block existing on the second state path, setting a state of a specific state node of the generated second set of state nodes of the state database of the current block by using the second value, retrieving a second set of sibling state nodes for the one or more state nodes included in the state database of the previous block existing on the second state path, and associating the retrieved second set of sibling state nodes with the second set of state nodes of the state database of the current block.

According to an embodiment, associating the retrieved second set of sibling state nodes with the second set of state nodes of the state database of the current block may include determining whether or not a version of the current block is stored in the one or more state nodes included in the state database of the previous block existing on the second state path, and when it is determined that the version of the current block is stored, removing the version of the current block stored in a corresponding state node.

According to an embodiment, associating the retrieved second set of sibling state nodes with the second set of state nodes of the state database of the current block may include determining whether or not there exists a state node generated by copying the second set of sibling state nodes onto the state database of the current block, and when it is determined that there exists the state node generated by copying the second set of sibling state nodes onto the state database of the current block, storing the version of the current block in the second set of sibling state nodes from which the corresponding state node is excluded.

According to an embodiment, the version of the current block has a greater value than the version of the previous block.

According to an embodiment, the method may further include determining whether or not the current block is finalized, and when it is determined that the current block is finalized, removing, from the state nodes included in the state database of the previous block, a state node that does not include a higher version than the version of the previous block.

According to an embodiment, the method may further include calculating a hash value for each of the state nodes on the state database of the current block using a hash function, and storing the hash value for each of the generated state nodes in association with the state database of the current block.

According to an embodiment, the hash value for each of the state nodes on the state database of the current block is calculated in the form of a Merkle tree.

According to an embodiment, the method may further include receiving a request to prove a specific state node on the state database of the current block from the client, and in response to the received request to prove, returning hash values of a plurality of state nodes necessary to extract a hash value of a Merkle root from the hash value of the specific state node on the state database of the current block.

According to an embodiment, calculating the hash value for each of the state nodes on the state database of the current block using the hash function may include constructing some of a plurality of state nodes on the state database of the current block into a radix tree form, and calculating a hash value for each of the state nodes on the state database of the current block which are constructed in the radix tree form.

According to another embodiment, there may be provided a computer program stored in a computer-readable recording medium for executing the method for managing states for the blockchain including the state database of the tree structure described above on a computer.

A system for managing states for a blockchain according to another embodiment is provided, which may include a communication module configured to receive a first transaction including a first state path and a first value from a client, a memory, and at least one processor connected to the memory and configured to execute at least one computer-readable program included in the memory. At least one processor may include instructions for generating a first set of state nodes for generating a state database of a current block, based on one or more state nodes included in a state database of a previous block existing on the first state path, setting a state of a specific state node of the generated first set of state nodes of the state database of the current block by using the first value, retrieving a first set of sibling state nodes for one or more state nodes included in the state database of the previous block existing on the first state path, and associating the retrieved first set of sibling state nodes with the first set of state nodes of the state database of the current block.

According to various embodiments of the present disclosure, by configuring the state database corresponding to the block in the tree structure to thus define different consensus rules for each divided subtree and maintain small blockchains, consensus rules can be set to meet the various requirements (e.g., scalability, security, decentralization, and the like) of the applications running on the system. For example, by applying the sharding technique, a sub-set (or sub-tree) of the tree structure can be maintained as the shards.

According to various embodiments of the present disclosure, the state database of the current block is simply able to include the states of the state database of the previous block without copying all the contents of the state information included in the state database of the previous block, i.e., by utilizing the version and reference only, so that the processor can effectively minimize copying and storing of redundant data.

According to various embodiments of the present disclosure, the processor can effectively reference and use the state information and the like on the previous block that is not changed by a plurality of transactions.

According to various embodiments, when the current block is finalized, the processor can remove one or more state nodes including redundant or unnecessary information to efficiently manage data.

According to various embodiments of the present disclosure, when a branch occurs in a blockchain including a state database of a tree structure, upon finalization of a block linked to one chain, the state nodes of the state database of the previous block that is not linked by reference, the state nodes linked to other chains, and the like can all be removed, thus allowing effective management of computing resources.

According to various embodiments of the present disclosure, by calculating a hash value by using the state node of the state database of each block forming the blockchain, and forming the calculated hash value in the form of a Merkle tree, transaction validity can be effectively managed.

According to various embodiments of the present disclosure, the client can simply prove the validity of the transaction by calculating the same Merkle root hash value by applying the hash function recursively along the path based on the returned hash value.

According to various embodiments of the present disclosure, by generating a spatially optimized tree structure as described above, when receiving a request to prove a specific state node from a client, it is possible to return only fewer hash values than when the radix tree form is not constructed, thereby increasing data processing efficiency.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawing, in which:

FIG. 1 is a diagram illustrating an example in which each of systems connected to a blockchain network including a state database of a tree structure processes a transaction according to an example embodiment;

FIG. 2 is a block diagram illustrating internal configurations of a client and an information processing system according to an example embodiment;

FIG. 3 is a diagram illustrating an example in which a state database of the current block is generated based on a first transaction according to an example embodiment;

FIG. 4 is a diagram illustrating an example in which state nodes of the state database of the current block are generated or updated based on a second transaction according to an example embodiment;

FIG. 5 is a diagram illustrating an example of removing a state node upon finalization of the current block according to an example embodiment;

FIG. 6 is a diagram illustrating an example in which a blockchain with a plurality of linked chains is finalized according to an example embodiment;

FIG. 7 is a diagram illustrating an example of converting each state node linked to the state database of the block into a hash value and proving the same according to an example embodiment; and

FIG. 8 is a flowchart illustrating an example of a method for managing states for a blockchain including a state database of a tree structure according to an example embodiment.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. In addition, in the following description of the embodiments, duplicate descriptions of the same or corresponding components may be omitted. However, even if descriptions of components are omitted, it is not intended that such components are not included in any embodiment.

Advantages and features of the disclosed embodiments and methods of accomplishing the same will be apparent by referring to embodiments described below in connection with the accompanying drawings. However, the present disclosure is not limited to the embodiments disclosed below, and may be implemented in various different forms, and the present embodiments are merely provided to make the present disclosure complete, and to fully disclose the scope of the invention to those skilled in the art to which the present disclosure pertains.

The terms used herein will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in a specific case, a term is arbitrarily selected by the applicant, and the meaning of the term will be described in detail in a corresponding description of the embodiments. Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to reproduce one or more processors. Accordingly, as an example, the “module” or “unit” may include components such as software components, object-oriented software components, class components, and task components, and at least one of processes, functions, attributes, procedures, subroutines, program code, segments of program code, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

According to an embodiment of the present disclosure, the “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination of processing devices, e.g., a combination of a DSP and a microprocessor, a plurality of microprocessors, one or more microprocessors in conjunction with a DSP core, or any other combination of such configurations. In addition, the “memory” should be interpreted broadly to encompass any electronic component capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with a processor is in electronic communication with the processor.

In the present disclosure, a “state node” is one of the elements that form a state database of the tree structure, and may refer to a data access point that includes one or more pieces of information (e.g., a state of the state node) or the like in the tree structure or represents one or more functional units. That is, in the present disclosure, each block may include a state database including a plurality of state nodes.

In the present disclosure, a “transaction” in the state database having the tree structure may correspond to data/information for changing or updating the state of the state node included in the tree structure. According to an embodiment, the transaction may include a state path, a value, and the like.

In the present disclosure, a “state” is data including a value, information about a child state node, or other meta information, and the state of the state node in the state database of the tree structure may be changed or updated by the transaction.

In the present disclosure, “sharding” may refer to an on-chain or off-chain solution that provides scalability to the blockchain by partitioning the entire tree structure forming the state database and then processing the partitioned sub-trees in parallel. Since each sub-tree managed with the shard is processed on a separate small blockchain instance, there can be an effect of greatly increased total throughput of the blockchain.

In the present disclosure, a “version” may be expressed as an epoch indicating a specific value, and used for referencing the state node. For example, the version may be implemented in the form of a set or list of states.

In the present disclosure, a “proof” may refer to an operation, computation, or process of proving the validity of a transaction based on a consensus algorithm, and may include the process or the like of checking whether or not protocol rules are being followed, whether or not the transaction is processed in a reliable way, whether or not the block is valid, and the like.

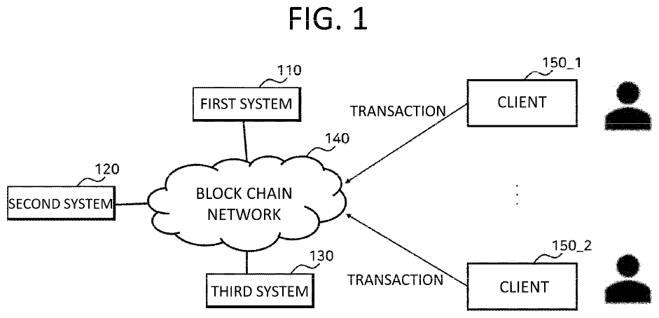

FIG. 1 is a diagram illustrating an example in which each of systems 110, 120, and 130 connected to a blockchain network 140 including a state database of a tree structure processes a transaction according to an embodiment. As illustrated, the blockchain network 140 may receive a transaction from a client 150. In this case, there may be one or more clients 150 that generate a transaction and transmit the generated transaction to the blockchain network 140. In addition, the blockchain network 140 may receive a separate transaction from each client 150, or receive a plurality of transactions from one client 150.

When the blockchain network 140 receives the transaction, each of the systems 110, 120, and 130 connected to the blockchain network 140 may generate a new block to process the transaction. For example, each of the systems 110, 120, and 130 may be the state node forming the blockchain network 140, and may be a system for processing a transaction and generating a new block to form a blockchain. That is, the first system 110, the second system 120, the third system 130, and the like connected to the blockchain network 140 may generate a new block associated with the received transaction. In this case, the new block may be generated to include all of information on a pre-processed transaction and the like, information on a newly received transaction, and the like. For example, the new block may refer to a current block configured to be linked to the previous block that includes information about the pre-processed transaction or the like.

According to an embodiment, the block generated by each of the systems 110, 120, and 130 may include epoch information. In this case, the epoch is information for associating the previous block with the current block, and may indicate the version of the block. In this case, each block may include the epoch information of different values. For example, when the epoch of the previous block corresponds to “e”, the epoch of the newly generated current block may correspond to “e+1”. That is, the epoch of the newly generated block may have a greater value than the epoch of the previous block that is previously generated.

According to an embodiment, the state database of block may be generated in the tree structure. In this case, the tree structure is a special form of a graph in which a plurality of state nodes are linked by branches, and may refer to a data structure including a hierarchical structure. In this case, the transaction may include a state path, a value, and the like for generating a state database of a tree structure. For example, when a transaction with a path “/a/b” and a value “G” is received, a current block may be generated, which causes the state of the state node to be changed or updated based on the corresponding state path and value. In this way, by configuring the state database corresponding to the block in the tree structure to thus define different consensus rules for each divided subtree and maintain small blockchains, consensus rules can be set to meet the various requirements (e.g., scalability, security, decentralization, and the like) of the applications running on the system. For example, by applying the sharding technique, a sub-set (or sub-tree) of the tree structure can be maintained as the shards.

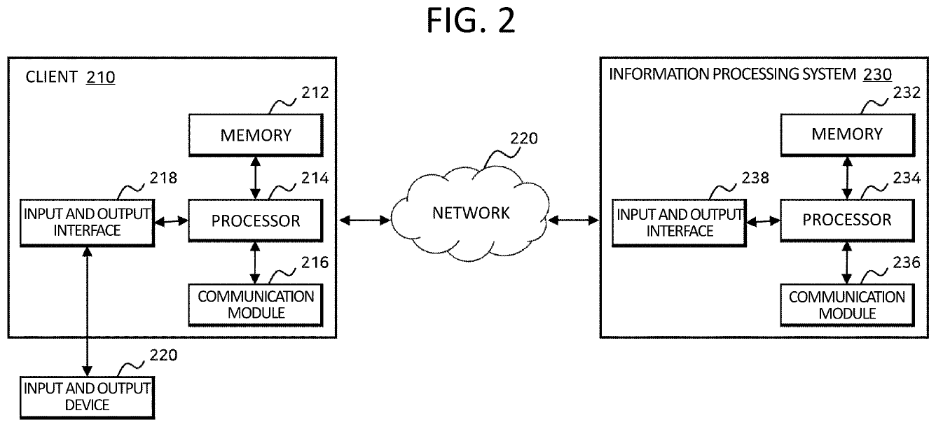

FIG. 2 is a block diagram illustrating internal configurations of a client 210 and an information processing system 230 according to an embodiment. The client 210 may refer to any computing device capable of wired/wireless communication to generate or transmit a transaction, and as illustrated, the client 210 may include a memory 212, a processor 214, a communication module 216, and an input and output interface 218. Likewise, the information processing system 230 is a system for processing a transaction and generating a new block of a tree structure (e.g., a state management system for a blockchain including a state database of a tree structure), and may include a memory 232, a processor 234, a communication module 236, and an input and output interface 238. As illustrated in FIG. 2, the client 210 and the information processing system 230 may be configured to communicate information and/or data through a network 220 by using the respective communication modules 216 and 236. In addition, an input and output device 240 may be configured to input information and/or data to the client 210 or to output information and/or data generated from the client 210 through an input and output interface 218.

The memories 212 and 232 may include any non-transitory computer-readable recording medium. According to an embodiment, the memories 212 and 232 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the client 210 or the information processing system 230 as a separate permanent storage device that is distinct from the memory. In addition, an operating system and at least one program code (e.g., a code for generating and transmitting a transaction) may be stored in the memories 212 and 232.

These software components may be loaded from a computer-readable recording medium separate from the memories 212 and 232. Such a separate computer-readable recording medium may include a recording medium directly connectable to the client 210 and the information processing system 230, and may include a computer-readable recording medium such as a floppy drive, a disk, a tape, a DVD/CD-ROM drive, a memory card, and so on, for example. As another example, the software components may be loaded into the memories 212 and 232 through the communication modules rather than the computer-readable recording medium.

The processors 214 and 234 may be configured to process the instructions of the computer program by performing basic arithmetic, logic, and input and output operations. The instructions may be provided to the processors 214 and 234 from the memories 212 and 232 or the communication modules 216 and 236. For example, the processors 214 and 234 may be configured to execute the received instructions according to program code stored in a recording device such as the memories 212 and 232.

The communication modules 216 and 236 may provide a configuration or function for the client 210 and the information processing system 230 to communicate with each other through the network 220, and may provide a configuration or function for the client 210 and/or the information processing system 230 to communicate with another client or another system (e.g., a separate cloud system or the like). For example, a request or data (e.g. a transaction or the like including a path, a value, and the like) generated by the processor 214 of the client 210 according to the program code stored in the recording device such as the memory 212 or the like may be transmitted to the information processing system 230 through the network 220 under the control of the communication module 216.

The input and output interface 218 may be a means for interfacing with the input and output device 240. As an example, the input device may include a device such as a camera, a keyboard, a microphone, a mouse, and so on, which includes an audio sensor and/or an image sensor, and the output device may include a device such as a display, a speaker, a haptic feedback device, and so on. As another example, the input and output interface 218 may be a means for interfacing with a device, such as, for example, a touch screen or the like that integrates a configuration or function for performing inputting and outputting. While FIG. 2 illustrates that the input and output device 240 is not included in the client 210, embodiments are not limited thereto, and it may be configured as one device with the client 210. In addition, the input and output interface 238 of the information processing system 230 may be a means for interfacing with a device (not illustrated) for inputting or outputting, which may be connected to the information processing system 230 or included in the information processing system 230. In FIG. 2, while the input and output interfaces 218 and 238 are illustrated as the components configured separately from the processors 214 and 234, embodiments are not limited thereto, and the input and output interfaces 218 and 238 may be configured to be included in the processors 214 and 234.

The client 210 and the information processing system 230 may include more components than those illustrated in FIG. 2. Meanwhile, most of the related components may not necessarily require exact illustration. According to an embodiment, the client 210 may be implemented to include at least a part of the input and output device 240 described above. In addition, the client 210 may further include other components such as a transceiver, a global positioning system (GPS) module, a camera, various sensors, a database, and the like. For example, when the client 210 is a smartphone, it may generally include components included in the smartphone, and for example, it may be implemented such that various components such as an acceleration sensor, a gyro sensor, a camera module, various physical buttons, buttons using a touch panel, input and output ports, a vibrator for vibration, and the like are further included in the client 210.

The processor 234 of the information processing system 230 may be configured to manage, process, and/or store the information and/or the data received from a plurality of clients and/or a plurality of external systems. According to an embodiment, the processor 234 may receive a transaction including a path and a value from the client 210. Then, the processor 234 may generate a first set of state nodes for generating a state database of the current block, based on one or more state nodes included in the state database of the previous block existing on the path. After that, the processor may use a value to set the state of a specific state node of the generated first set of state nodes of the state database of the current block.

According to an embodiment, the processor 234 may retrieve a first set of sibling state nodes for one or more state nodes included in the state database of the previous block existing on the path, and associate the retrieved first set of sibling state nodes with the first set of state nodes of the state database of the current block. For example, the processor 234 may store a version of the current block in the retrieved first set of sibling state nodes to associate the first set of sibling state nodes with the first set of state nodes in the state database of the current block.

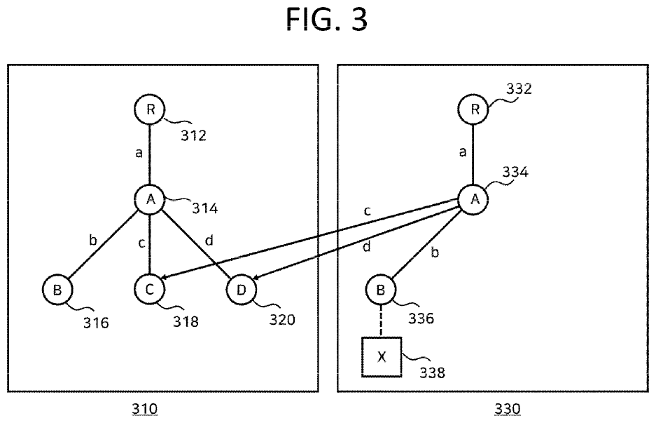

FIG. 3 is a diagram illustrating an example in which a state database 330 of the current block is generated based on a first transaction according to an embodiment. According to an embodiment, when a transaction including a state path, a value, and the like is received, the state database 330 corresponding to the result of processing the transaction may be generated. As described above, when the transaction is received, the state database 330 of the current block may be generated, in which the state of a specific state node is changed or updated using the corresponding transaction.

According to an embodiment, the processor (e.g., at least one processor of the information processing system) may receive a first transaction including a first state path and a first value from the client. In the illustrated example, the state path of the first transaction may correspond to “/a/b”, and the value may correspond to “X”. In other words, the processor may change or update the state of a state node B 336 corresponding to the “/a/b” path according to a value “X” 338 to generate the state database 330 of the current block. In this case, the state database 330 of the current block may have a greater epoch or version than a state database 310 of the previous block. For example, when the epoch of the previous block is “e”, the epoch of the current block may correspond to “e+1”.

According to an embodiment, when the first transaction is received, the processor may generate a first set of state nodes for generating the state database 330 of the current block based on one or more state nodes included in the state database 310 of the previous block existing on the first state path. For example, the processor may copy a root state node 312 of the state database 310 of the previous block to generate a root state node 332 of the state database 330 of the current block. Then, the processor may copy a state node A 314 and a state node B 316 of the state database 310 of the previous block existing on the “/a/b” path to generate a state node A 334 and the state node B 336 of the state database 330 of the current block. After generating the state nodes, the processor may use the first value to set the state of a specific state node of the generated first set of state nodes of the state database of the current block. For example, the processor may change or update the state of the state node B 336 based on the value “X” 338.

Then, the processor may retrieve the first set of sibling state nodes for one or more state nodes included in the state database 310 of the previous block existing on the first state path. In the illustrated example, a state node C 318 and a state node D 320 may be retrieved as the sibling state nodes of the state node A 314 or the state node B 316. When the sibling state nodes are retrieved, the processor may associate the first set of sibling state nodes with the first set of state nodes of the state database 330 of the current block. Specifically, the processor may store the version of the current block in the retrieved first set of sibling state nodes. For example, the epoch “e+1” corresponding to the version of the state database 330 of the current block may be stored in the state node C 318 and the state node D 320. That is, the state database 330 of the current block may store its own epoch in the first set of sibling state nodes of the state database 310 of the previous block, and then use the reference to share the state information included on the state database 310 of the previous block. With such a configuration, the state database 330 of the current block is simply able to include the states of the state database 310 of the previous block without copying all the contents of the state information included in the state database 310 of the previous block, i.e., by utilizing the version and reference only, so that the processor can effectively minimize copying and storing of redundant data.

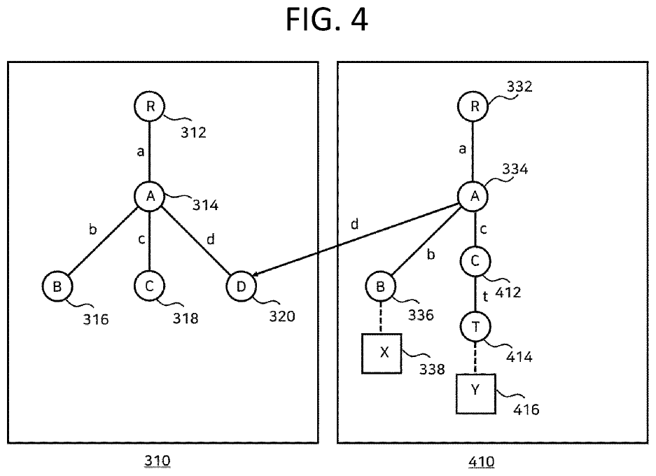

FIG. 4 is a diagram illustrating an example in which the state nodes of a state database 410 of the current block are generated or updated based on a second transaction according to an embodiment. According to an embodiment, a plurality of transactions may be received from one client, or a plurality of transactions may be received from a plurality of clients. In this case, the plurality of received transactions may be sequentially processed based on the order they are received, a priority of the transaction, and the like. The illustrated example may show that the state database (e.g., 330 in FIG. 3) of the current block generated by the first transaction is updated by the subsequent second transaction.

According to an embodiment, the processor may receive a second transaction including a second state path and a second value from the client. In the illustrated example, the state path of the second transaction may correspond to “/a/c”, and the value may correspond to “{t:Y}”. In other words, the processor may change or update the state of the state node corresponding to the “/a/c” path according to the value “{t:Y}” to generate the state database 410 of the current block. In this case, the current block may refer to a block having a greater epoch, version, and the like than the previous block. For example, when the epoch of the previous block is “e”, the epoch of the current block may correspond to “e+1”.

According to an embodiment, when the second transaction is received, the processor may generate a second set of state nodes for generating the state database 410 of the current block based on one or more state nodes included in the state database 310 of the previous block existing on the second state path. For example, the processor may copy the state node A 314 and the state node C 318 of the state database 310 of the previous block existing on the second state path to generate the state node A 334 and a state node B 412 of the state database 410 of the current block. In this case, when there already exists the state node (e.g., the state node A 334) generated by the pre-processed transaction (e.g., the first transaction), copying the corresponding state node may be omitted.

According to an embodiment, the processor may use the second value to set the state of a specific state node of the generated second set of state nodes of the state database 410 of the current block. Specifically, when the second value includes another state path that is not included in the state database 310 of the previous block, the processor may generate a state node corresponding to the corresponding state path and set the state of the state node. For example, when the second value corresponds to “{t:Y}”, the processor may generate a state path “t” and a state node T 414 linked to the “/a/c” state path, and change or update the state of the generated state node T 414 based on a value “Y” 416. As a result, the state of the state node T 414 corresponding to the state path of “/a/c/t” may be changed or updated to “Y”.

Then, the processor may retrieve the second set of sibling state nodes for one or more state nodes included in the state database 310 of the previous block existing on the second path. In the illustrated example, the state node B 316 and the state node D 320 may be retrieved as the sibling state nodes of the state node A 314 or the state node C 318. After that, the processor may associate the retrieved second set of sibling state nodes with the second set of state nodes of the state database 410 of the current block.

According to an embodiment, the processor may determine whether or not the version of the state database 410 of the current block is stored in one or more state nodes included in the state database 310 of the previous block existing on the second state path, and when it is determined that the version of the state database 410 of the current block is stored, the processor may remove the version of the state database 410 of the current block stored in the corresponding state node. In the illustrated example, one or more state nodes included in the state database 310 of the previous block existing on the second state path may correspond to the state node A 314 and the state node C 318, and, as shown in the example of FIG. 3, after the first transaction is processed, the state node C 318 may be stored with the version of the current block. In this case, in the process of processing a transaction that modifies the state node C 412 included in the state database 410 of the current block, it is not necessary for the processor to reference the state node C 318 of the state database 310 of the previous block any more, and the processor can remove the version of the current block stored in the state node C 318.

Then, the processor may determine whether or not there is a state node generated by copying the second set of sibling state nodes onto the state database 410 of the current block, and when it is determined that there is the state node generated by copying the second set of sibling state nodes onto the state database 410 of the current block, the processor may store the version of the current block in the second set of sibling state nodes from which the corresponding state node is excluded. For example, when there already exists the state node B 336 of the state database 410 of the current block which is generated by copying the state node B 316 and the state node D 320 that are retrieved as the second set of sibling state nodes, the processor may store the version of the current block in the state node D 320 of the state database 310 of the previous block, except for the state node B 316 of the state database 310 of the previous block. Consequently, the state database 410 of the current block may be configured to reference only the state node D 320 of the state database 310 of the previous block. With such a configuration, the processor can effectively reference and use the state information and the like on the state database 310 of the previous block that is not changed by a plurality of transactions.

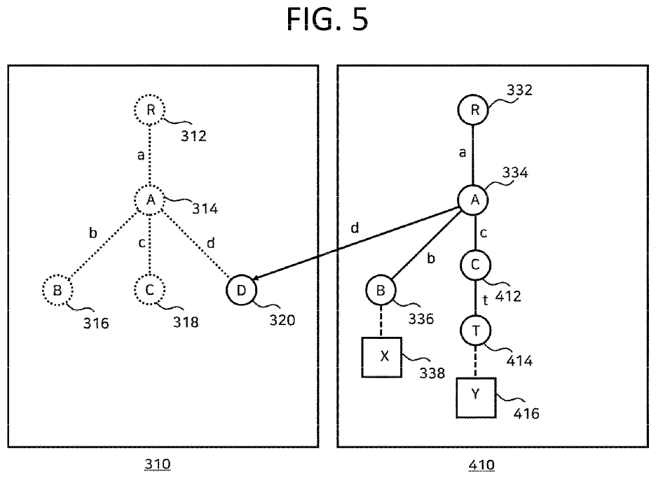

FIG. 5 is a diagram illustrating an example of removing a state node upon finalization of the current block according to an embodiment. As described above, after processing a plurality of transactions (e.g., the first transaction, the second transaction, and the like), the current block may be finalized. According to an embodiment, the processor may determine whether or not the current block is finalized, and when it is determined that the current block is finalized, the processor may remove, from the state nodes included in the state database 310 of the previous block, a state node that does not include a version higher than the version of the previous block. For example, it may be determined whether or not the current block is finalized based on a predetermined consensus on the blockchain network. In this case, the epoch corresponding to the version of the current block is “e+1”, and the epoch corresponding to the version of the previous block is “e”, that is, the version of the current block may be higher than the version of the previous block.

Specifically, the processor may start from the root state node 312 of the state database 310 of the previous block, and retrieve down one or more leaf state nodes while going down. The leaf state node as used herein may refer to any state node that does not have child state nodes. For example, the processor may retrieve the state node B 316, the state node C 318, and the state node D 320 corresponding to the leaf state node. The processor then may determine whether or not the epochs stored in the state node B 316, the state node C 318, and the state node D 320 is higher than the epoch of the previous block. In the illustrated example, since the epochs stored in the state node B 316 and the state node C 318 and the epoch of the previous block are the same as “e”, the state node B 316 and the state node C 318 may be removed. At this time, the state node D 320 may remain without being removed, since “e+1” corresponding to the version of the current block is stored therein.

Then, the processor may retrieve a higher state node of the leaf state node. For example, the processor may retrieve the state node A 314 and determine whether or not the epoch stored in the state node A 314 is higher than the epoch of the previous block. In the illustrated example, since the epoch stored in the state node A 314 and the epoch of the previous block are the same as “e”, the state node A 314 may be removed. In addition, likewise, the root state node 312 of the state database 310 of the previous block may also be removed.

In FIG. 5, although it has been described above that the epoch “e” corresponding to the version of the previous block is stored in all state nodes of the state database 310 of the previous block, embodiments are not limited thereto. For example, the state database 310 of the previous block may include one or more state nodes that do not include any version. In this case, the state node that does not include any version may also be removed when the current block is finalized. With such a configuration, when the current block is finalized, the processor may remove one or more state nodes including redundant or unnecessary information to efficiently manage data.

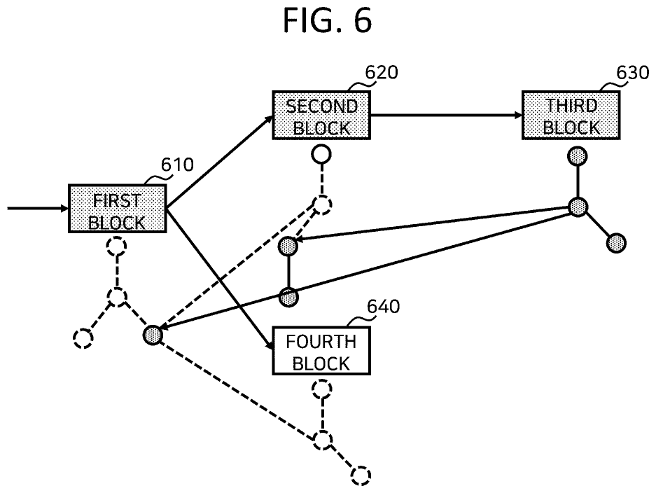

FIG. 6 is a diagram illustrating an example in which a blockchain with a plurality of linked chains is finalized according to an embodiment. As illustrated, two or more new blocks may be linked to one block. For example, when changing the policy of the block or the like, a fork and the like may be generated, and a branch may occur on the blockchain due to the transaction propagation speed of state nodes linked on the blockchain network. In the illustrated example, after a first block 610 is generated, the blockchain is branched such that one chain in which a second block 620 and a third block 630 are linked, and another chain in which a fourth block 640 is linked may be generated.

In the case of a blockchain in which a branch is generated, when one chain is finalized, the blocks, the state nodes, and the like included in the other one may be removed. In the illustrated example, when the third block 630 is finalized, as described above with reference to FIG. 5, the state nodes on the state database of the first block 610 and on the state database of the second block 620, which are not linked by reference to the third block 630, may be removed. In addition, the state nodes on the state database of the fourth block 640 and on the state database of the fourth block 640, which are linked to a chain different from the finalized third block 630, may be removed. With such a configuration, when a branch occurs in a blockchain including a state database of a tree structure, upon finalization of a block linked to one chain, the state nodes of the state database of the previous block that is not linked by reference, the state nodes linked to other chains, and the like can all be removed, thus allowing effective management of computing resources.

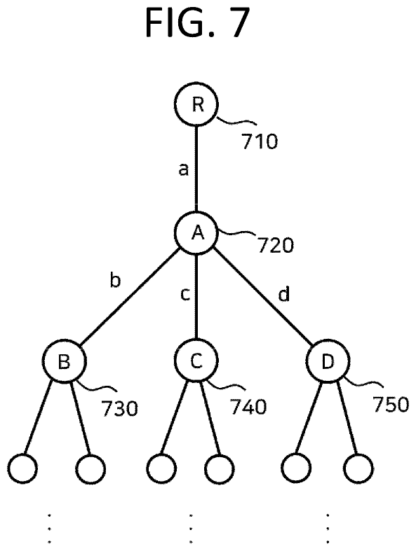

FIG. 7 is a diagram illustrating an example of converting each state node linked to a state database of a block into a hash value and proving the same according to an embodiment. According to an embodiment, the processor may convert each state node included in the state database of the block into a hash value. In this case, each state node may include a state changed or updated by one or more transactions. Specifically, the processor may use a hash function to calculate a hash value for each of the state nodes on the state database of the current block, and store each generated hash value for the state node in association with the current block. In this case, the hash value for each of the state nodes on the state database of the current block may be calculated in the form of a Merkle tree.

In the illustrated example, the hash value of a state node A 720 may be calculated by using all of the hash values of a state node B 730, a state node C 740, and a state node D 750 corresponding to the child state nodes of the state node A 720 and the paths (e.g., “b”, “c”, and “d”) between the state node A 720 and each child state node, and the like. Specifically, the hash function may be calculated by applying a hash function to a value obtained by combining the hash value of the state node B 730, the hash value of the state node C 740 and the hash value of the state node D 750 and the paths between the state node A 720 and each child state node. For example, the hash value “proofHash(A)” of the state node A 720 may be calculated as: hash(join(“b”, proofHash(B), “c”, proofHash(C), “d”, proofHash(D))). Here, the function “join” may correspond to a join function that combines strings. Likewise, the hash value of the root state node 710 may correspond to a Merkle root calculated in the form of a Merkle tree by comprehensively using all state nodes, paths, and the like of lower levels.

According to an embodiment, a cryptographic hash function may be used to calculate the hash value of the state node. For example, a hash value calculated by SHA256 hash function may yield a unique hash value according to an input value. That is, different hash values may be calculated when any one of the hash values and paths of the child state nodes of the state node A 720 is different. With such a configuration, by calculating a hash value by using the state node of the state database of each block forming the blockchain, and forming the calculated hash value in the form of a Merkle tree, transaction validity can be effectively managed.

In addition, the processor can simply verify the validity of the transaction by calculating a hash value by using the state, state path, and the like of each state node included in the state database of the block. When the processor receives from the client a request to prove a specific state node in the state database of the current block, in response to the received request to prove, the processor may return hash values of a plurality of state nodes necessary to extract a hash value of the Merkle root from a hash value of a specific state node on the state database of the current block. For example, when receiving a request to prove the state node C 740 from the client, the processor may return hash values, paths, and the like of all state nodes existing between the root state node 710 and the state node C 740 to the client. In this case, the client can simply prove the validity of the transaction by calculating the same Merkle root hash value by applying the hash function recursively along the path based on the returned hash value.

According to an embodiment, the processor may construct some of the state nodes on the state database of the block into a form of a radix tree. For example, the radix tree may refer to a space-optimized tree structure in which a new state node is generated with a common part among the child state nodes linked to the parent state node by a single path, and the path is reconstructed. By generating a spatially optimized tree structure as described above, when receiving a request to prove a specific state node from a client, it is possible to return only fewer hash values than when the radix tree form is not constructed, thereby increasing data processing efficiency.

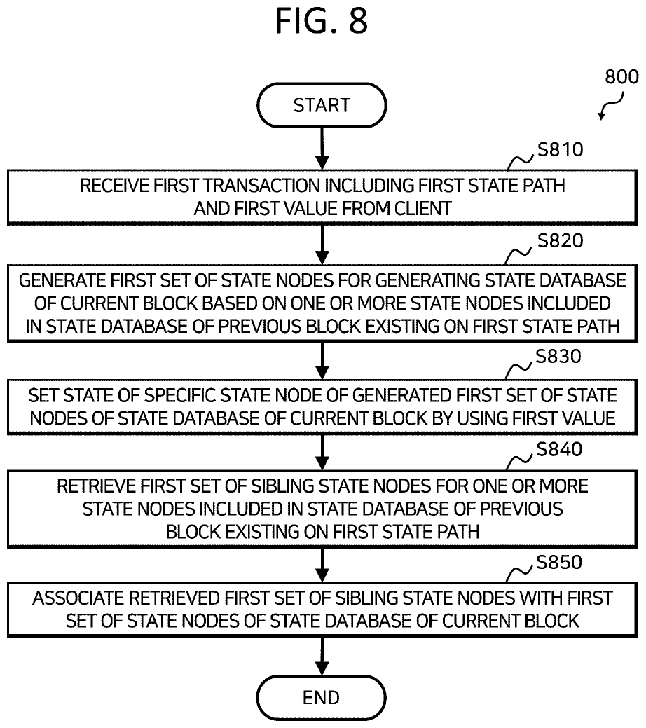

FIG. 8 is a flowchart illustrating an example of a method 800 for managing states for a blockchain including a state database of a tree structure according to an embodiment. According to an embodiment, the method 800 for managing states for a blockchain may be performed by an information processing system (e.g., at least one processor of the information processing system). The method 800 for managing states for a blockchain may be initiated by the processor receiving a first transaction including a first state path and a first value from a client (S810). When receiving the first transaction, the processor may generate a first set of state nodes for generating the state database of the current block, based on one or more state nodes included in the state database of the previous block existing on the first state path (S820).

The processor may use the first value to set the state of a specific state node of the generated first set of state nodes of the state database of the current block (S830). For example, the processor may set the state of a state node corresponding to the lowest level of the first state path based on the first value. With such a configuration, the processor can change or update the state of the state node existing on the state path of one transaction.

Then, the processor may retrieve a first set of sibling state nodes for one or more state nodes included in the state database of the previous block existing on the first state path (S840). In addition, the processor may associate the retrieved first set of sibling state nodes with the first set of state nodes of the state database of the current block (S850). Specifically, the processor may store the version of the current block in the retrieved first set of sibling state nodes to associate the first set of sibling state nodes with the first set of state nodes of the state database of the current block. With such a configuration, the processor can copy the state information of the unchanged state node and simply share the state information of the state node included in the state database of the previous block by using a reference while excluding redundant information.

The method for managing states for a blockchain including the state database of the tree structure described above may be provided as a computer program stored in a computer-readable recording medium for execution in a computer. The medium may continuously store a program executable by a computer or temporarily store a program for execution or download. In addition, the medium may be a variety of recording means or storage means in a form in which a single piece of hardware or several pieces of hardware are combined, but is not limited to a medium directly connected to any computer system, and may be present on a network in a distributed manner. An example of the medium includes a medium that is configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of this disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

Although the embodiments described above have been described as utilizing aspects of the currently disclosed subject matter in one or more standalone computer systems, embodiments are not limited thereto, and may be implemented in conjunction with any computing environment, such as a network or distributed computing environment. Furthermore, aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some embodiments herein, various modifications and changes can be made without departing from the scope of the present disclosure, which can be understood by those skilled in the art to which the present disclosure pertains. Further, such modifications and changes are intended to fall within the scope of the claims appended herein.

1. A method for managing states for a blockchain including a state database of a tree structure, the method performed by at least one processor and comprising:
receiving a first transaction including a first state path and a first value from a client;
generating a first set of state nodes for generating a state database of a current block, based on one or more state nodes included in a state database of a previous block existing on the first state path;
setting a state of a specific state node of the generated first set of state nodes of the state database of the current block by using the first value;
retrieving a first set of sibling state nodes for the one or more state nodes included in the state database of the previous block existing on the first state path; and
associating the retrieved first set of sibling state nodes with the first set of state nodes of the state database of the current block;

2. The method according to claim 1, wherein the associating the retrieved first set of sibling state nodes with the first set of state nodes of the state database of the current block comprises storing a version of the current block in the retrieved first set of sibling state nodes.

3. The method according to claim 2, further comprising:
receiving a second transaction including a second state path and a second value from the client;
generating a second set of state nodes for generating a state database of the current block, based on one or more state nodes included in the state database of the previous block existing on the second state path;
setting a state of a specific state node of the generated second set of state nodes of the state database of the current block by using the second value;
retrieving a second set of sibling state nodes for the one or more state nodes included in the state database of the previous block existing on the second state path; and
associating the retrieved second set of sibling state nodes with the second set of state nodes of the state database of the current block.

4. The method according to claim 3, wherein the associating the retrieved second set of sibling state nodes with the second set of state nodes of the state database of the current block comprises:
determining whether a version of the current block is stored in the one or more state nodes included in the state database of the previous block existing on the second state path; and
when it is determined that the version of the current block is stored, removing the version of the current block stored in a corresponding state node.

5. The method according to claim 3, wherein the associating the retrieved second set of sibling state nodes with the second set of state nodes of the state database of the current block comprises:
determining whether a state node generated by copying the second set of sibling state nodes exists in the state database of the current block; and
when it is determined that the state node generated by copying the second set of sibling state nodes exists in the state database of the current block, storing the version of the current block in the second set of sibling state nodes from which the corresponding state node is excluded.

6. The method according to claim 1, wherein the version of the current block has a greater value than the version of the previous block.

7. The method according to claim 1, further comprising:
determining whether the current block is finalized; and
when it is determined that the current block is finalized, removing, from the state nodes included in the state database of the previous block, a state node that does not include a higher version than the version of the previous block.

8. The method according to claim 1, further comprising:
calculating a hash value for each of the state nodes in the state database of the current block using a hash function; and
storing the hash value for each of the generated state nodes in association with the state database of the current block.

9. The method according to claim 8, wherein the hash value for each of the state nodes in the state database of the current block is calculated in a form of a Merkle tree.

10. The method according to claim 9, further comprising:
receiving a request to prove a validity of a specific state node on the state database of the current block from the client; and
in response to the received request to prove, returning hash values of a plurality of state nodes necessary to extract a hash value of a Merkle root from the hash value of the specific state node in the state database of the current block.

11. The method according to claim 8, wherein the calculating the hash value for each of the state nodes on the state database of the current block using the hash function comprises:
constructing some of a plurality of state nodes in the state database of the current block into a radix tree form; and
calculating a hash value for each of the state nodes in the state database of the current block which are constructed in the radix tree form.

12. A non-transitory computer-readable recording medium storing instructions for executing the method according to claim 1.

13. A system for managing states for a blockchain, comprising:
a communication module configured to receive a first transaction including a first state path and a first value from a client;
a memory; and
at least one processor connected to the memory and configured to execute at least one computer-readable program included in the memory,
wherein the at least one processor includes instructions for:
generating a first set of state nodes for generating a state database of a current block, based on one or more state nodes included in a state database of a previous block existing on the first state path;
setting a state of a specific state node of the generated first set of state nodes of the state database of the current block by using the first value;
retrieving a first set of sibling state nodes for one or more state nodes included in the state database of the previous block existing on the first state path; and
associating the retrieved first set of sibling state nodes with the first set of state nodes of the state database of the current block.
